(19) United States
(12) Patent Application Publication
(10) Pub. No.: US 2016/0378018 A1
(43) Pub. Date: Dec. 29, 2016

(54) IMAGE FORMING APPARATUS

(71) Applicant: KYOCERA Document Solutions Inc., Osaka (JP)

(72) Inventors: Mitsuhiro Goda, Osaka (JP); Susumu Hanano, Osaka (JP)

(21) Appl. No.: 15/190,242

(22) Filed: Jun. 23, 2016

(30) Foreign Application Priority Data
Jun. 26, 2015 (JP) 2015-129226
Apr. 5, 2016 (JP) 2016-075612

(51) Int. Cl. G03G 15/08

(52) U.S. Cl. CPC G03G 15/0808

(57) ABSTRACT

An image forming apparatus includes a body, a photoreceptor unit, and a developing unit. The developing unit includes a first attaching/detaching lever that moves a developing sleeve from a first position to a second position by lifting the first attaching/detaching lever. The photoreceptor unit includes a second attaching/detaching lever that moves the developing sleeve from the first position to the second position by lifting the second attaching/detaching lever. The photoreceptor unit and the developing unit move the developing sleeve to the second position by lifting the first or second attaching/detaching lever so that the photoreceptor unit and the developing unit are individually detached from the body.

### INCORPORATION BY REFERENCE

The disclosures of Japanese Patent Application No. 2015-129226 filed on Jun. 26, 2015 including the specifications, drawings, and abstracts and Japanese Patent Application No. 2016-75612 filed on Apr. 5, 2016 including the specifications, drawings, and abstracts are incorporated herein by reference in their entireties.

### BACKGROUND

The present disclosure relates to an image forming apparatus.

In an image forming apparatus typified by a multifunctional peripheral, a photoreceptor included in an image forming part is irradiated with light based on image data so that an electrostatic latent image is formed on the photoreceptor. Then, charged toner is applied onto the electrostatic latent image to form a visible image, and the visible image is transferred onto a sheet of paper. Thereafter, the toner on the sheet is fixed onto the sheet with a fixing device included in the image forming apparatus. Subsequently, the sheet on which the toner has been fixed is discharged to the outside of the apparatus.

Techniques regarding an image forming apparatus including a photoreceptor unit and a developing unit have been known to date.

### SUMMARY

An image forming apparatus according to the present disclosure includes a body, a photoreceptor unit, and a developing unit. The photoreceptor unit includes a photoreceptor having a surface on which an electrostatic latent image is to be formed. The photoreceptor unit is detachably mounted on the body. The developing unit is detachably mounted on the body and includes a developing sleeve that supplies a developer to the photoreceptor. The developing sleeve is movable to a first position at which the developing sleeve is allowed to supply the developer to the photoreceptor and a second position at which the photoreceptor and the developing sleeve are separated from each other to avoid contact between the photoreceptor and the developing sleeve. The developing unit includes a first attaching/detaching lever that moves the developing sleeve from the first position to the second position by lifting the first attaching/detaching lever. The photoreceptor unit includes a second attaching/detaching lever that moves the developing sleeve from the first position to the second position by lifting the second attaching/detaching lever. The photoreceptor unit and the developing unit move the developing sleeve to the second position by lifting the first attaching/detaching lever or the second attaching/detaching lever so that the photoreceptor unit and the developing unit are individually detached from the body.

### BRIEF DESCRIPTION OF THE DRAWINGS

FIG. 1 illustrates a multifunctional peripheral to which an image forming apparatus according to an embodiment of the present disclosure is applied.

FIG. 2 is a perspective view illustrating configurations of a black photoreceptor unit and a black developing unit attached to a body of the multifunctional peripheral.

FIG. 3 is a perspective view illustrating a state in which the developing unit is attached to the photoreceptor unit.

FIG. 4 is a perspective view illustrating the photoreceptor unit.

FIG. 5 is a perspective view illustrating the developing unit.

FIG. 6 is a perspective view illustrating the developing unit from which a top cover is removed.

FIG. 7 is an enlarged view of a portion of the developing unit indicated by VII in FIG. 6.

FIG. 8 is an enlarged view of a portion of the developing unit indicated by VIII in FIG. 6.

FIG. 9 is a cross sectional view of the developing unit and the photoreceptor unit and illustrates a state in which a photoreceptor and a developing sleeve are in contact with each other.

FIG. 10 is a cross sectional view of the developing unit and the photoreceptor unit and illustrates a state in which the developing sleeve is separated from the photoreceptor.

FIG. 11 is a cross sectional view illustrating a state in which the developing unit is attached to the photoreceptor unit.

FIG. 12 is a cross sectional view illustrating a state in which the developing unit is attached to the photoreceptor unit.

FIG. 13 is a cross sectional view of the developing unit taken along a plane extending along a rotation axis of the photoreceptor.

FIG. 14 is a cross sectional view of the developing unit and the photoreceptor unit taken along a plane extending along the rotation axis of the photoreceptor.

FIG. 15 is a cross sectional view of the developing unit and the photoreceptor unit in a case where the developing sleeve is moved from a first position to a second position by using a first attaching/detaching lever.

FIG. 16 is a cross sectional view of the developing unit and the photoreceptor unit in a case where the developing sleeve is moved from the first position to the second position by using a second attaching/detaching lever.

### DETAILED DESCRIPTION

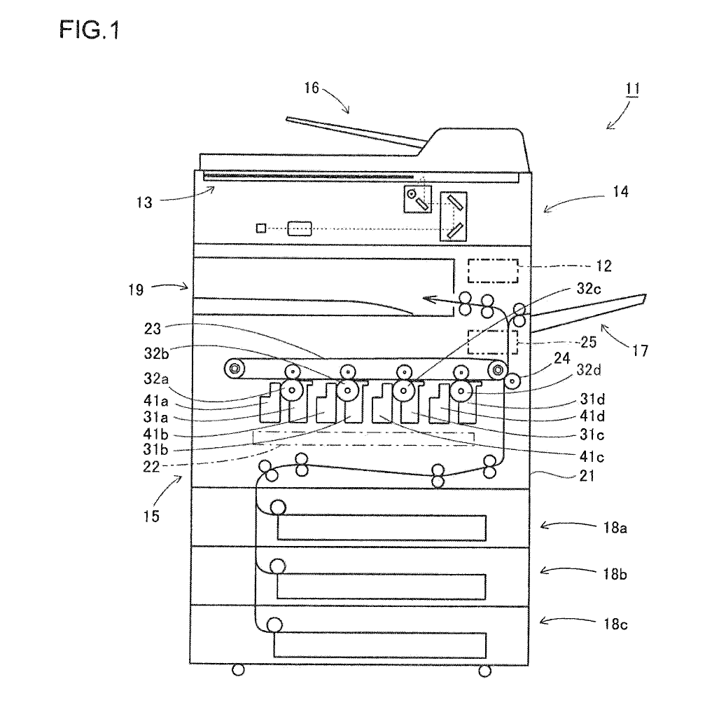

An embodiment of the present disclosure will be described hereinafter. FIG. 1 illustrates a multifunctional peripheral to which an image forming apparatus according to the embodiment of the present disclosure is applied.

As illustrated in FIG. 1, a multifunctional peripheral 11 is related to image processing and has a plurality of functions such as a copy function, a printer function, and a facsimile function. The multifunctional peripheral 11 includes a controller 12, an operation part 13, an image reading part 14, an image forming part 15, an auto document feeder (ADF) 16, a manual feed tray 17, three paper cassettes 18a, 18b, and 18c, a discharge part 19, and a body 21.

The controller 12 including a CPU controls the entire multifunctional peripheral 11. In FIG. 1, the controller 12 is schematically indicated by a chain line. The operation part 13 including a touch panel displays information from the multifunctional peripheral 11 and enables a user to input conditions for image formation, such as the number of copies and gradation, and instructions for turning on or off of a power supply. The image reading part 14 reads an image of a document placed on the ADF 16 serving as a document conveying device or a placing table. The image forming part 15 forms an image on a sheet set on the manual feed tray 17 or the paper cassettes 18a, 18b, and 18c and conveyed, based on image data read out by the image reading part 14 or image data transmitted to the multifunctional peripheral 11 via a network (not shown). The sheet on which the image has been formed by the image forming part 15 is discharged to the discharge part 19. Members constituting the image forming part 15 are attached to the body 21 mainly constituting a housing. An unillustrated front cover is attached to the front of the multifunctional peripheral 11.

The configuration of the image forming part 15 included in the multifunctional peripheral 11 will be described in more detail. The image forming part 15 includes a laser scanner unit (LSU) 22, a transfer belt 23 serving as an intermediate transfer body, and a secondary transfer roller 24. The LSU 22 is schematically indicated by a chain line. The multifunctional peripheral 11 includes the image forming part 15 of a so-called four tandem type.

The image forming part 15 corresponds to four colors of yellow, magenta, cyan, and black, and includes four photoreceptor units 31a, 31b, 31c, and 31d including photoreceptors 32a, 32b, 32c, and 32d, respectively, and four developing units 41a, 41b, 41c, and 41d.

The LSU 22 exposes the four photoreceptors 32a to 32d to light based on image data read out by the image reading part 14 and received image data. Based on color components of light used for the exposure, electrostatic latent images are formed on the photoreceptors 32a to 32d. Toners corresponding to the four colors are supplied from the developing units 41a to 41d onto the electrostatic latent images formed on the photoreceptors 32a to 32d respectively, so that toner images are formed on the photoreceptors 32a to 32d. The toner images formed on the photoreceptors 32a to 32d are primarily transferred onto the transfer belt 23. The toner images primarily transferred onto the transfer belt 23 is secondarily transferred onto a sheet by the secondary transfer roller 24, fixed on the sheet by the fixing part 25, and is discharged to the discharge part 19. In FIG. 1, the fixing part 25 is schematically indicated by a chain double-dashed line.

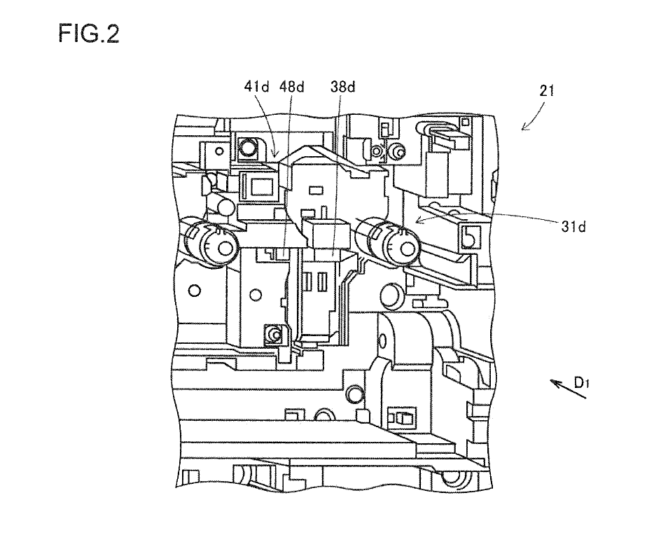

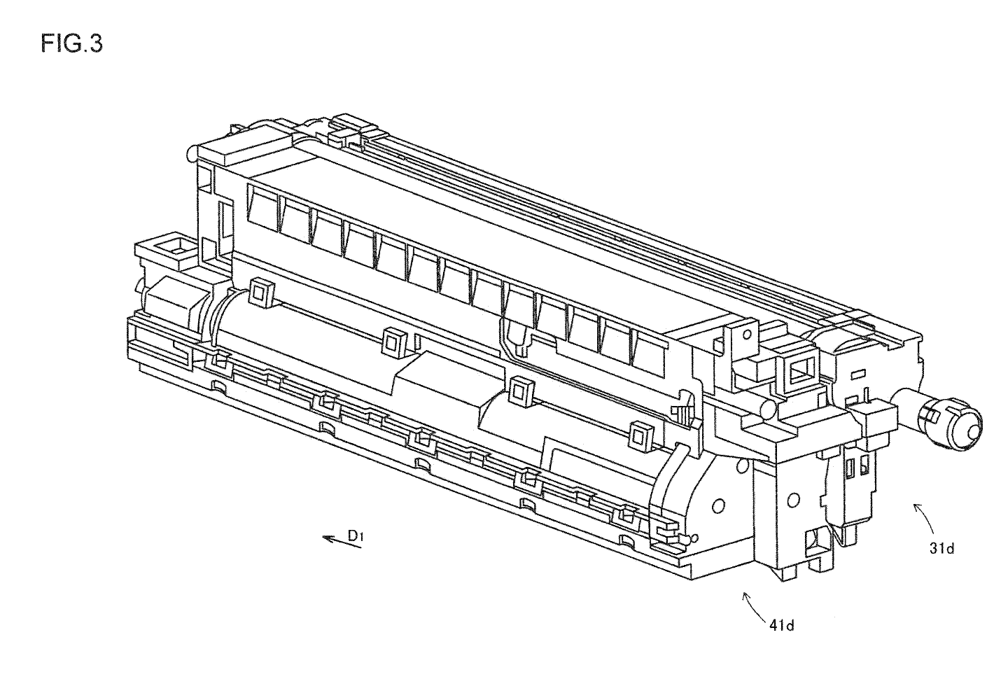

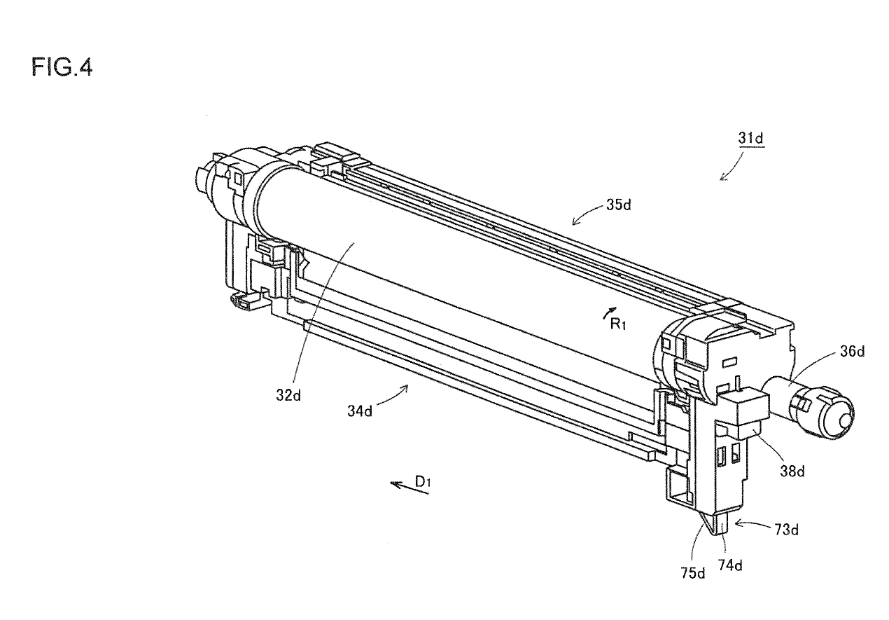

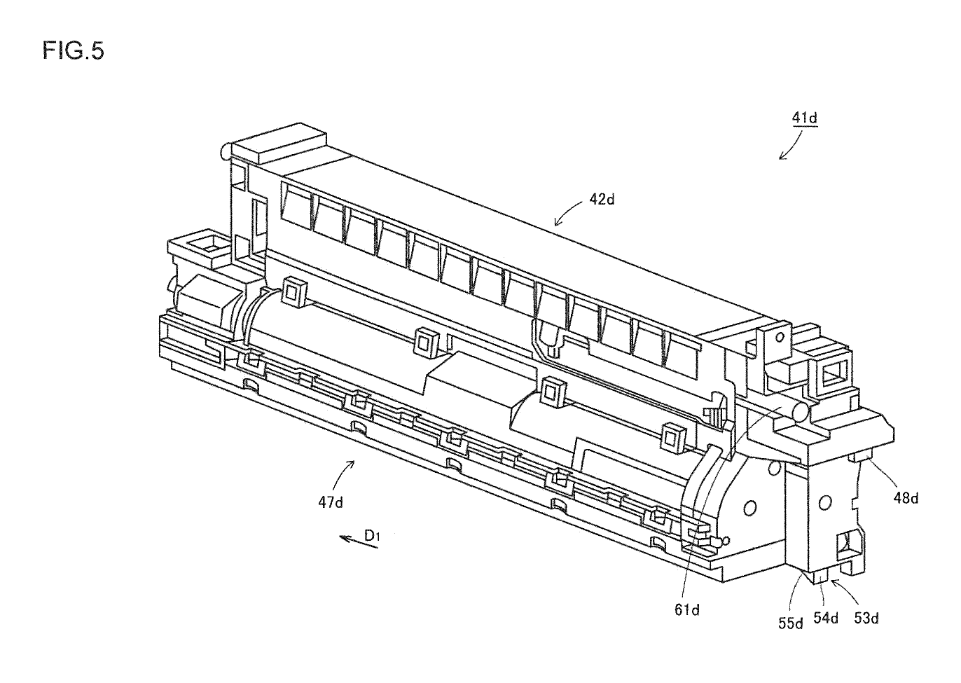

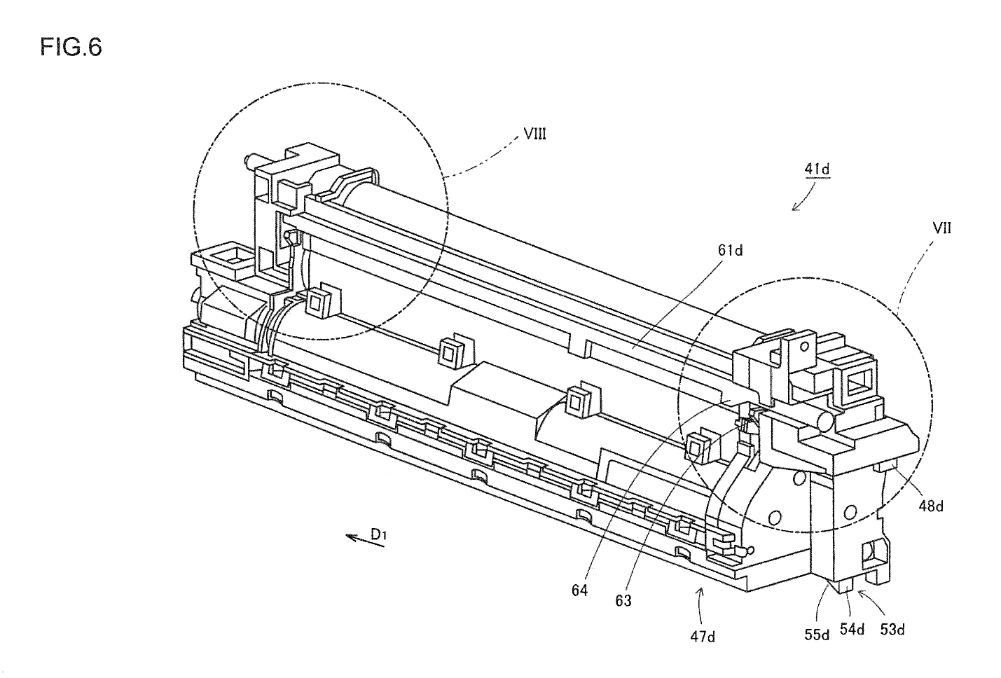

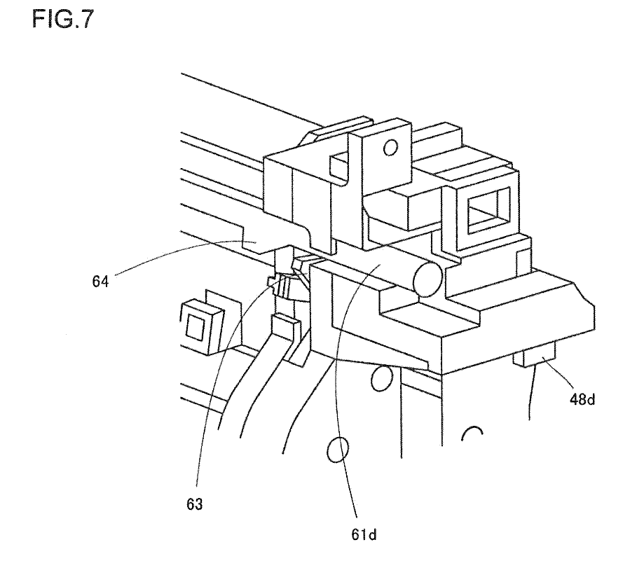

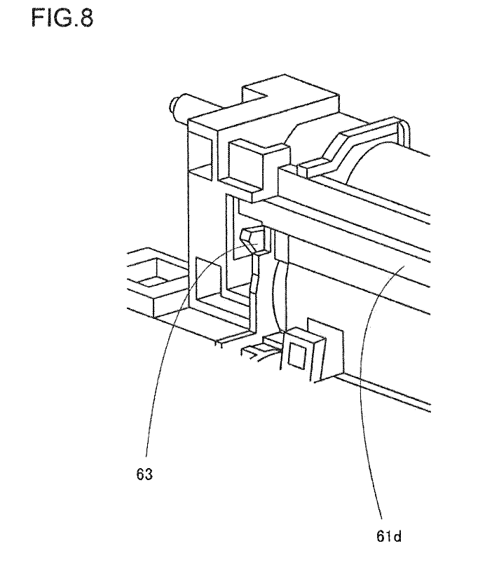

Specific configuration of the black photoreceptor unit 31d and the black developing unit 41d included in the image forming part 15 will now be described. FIG. 2 is a perspective view illustrating configurations of the black photoreceptor unit 31d and the black developing unit 41d attached to the body 21 of the multifunctional peripheral 11. FIG. 3 is a perspective view illustrating a state in which the developing unit 41d is attached to the photoreceptor unit 31d. FIG. 4 is a perspective view illustrating the photoreceptor unit 31d. FIG. 5 is a perspective view illustrating the developing unit 41d. FIG. 6 illustrates a state in which a top cover 42d described later is removed from the developing unit 41d illustrated in FIG. 5. FIG. 7 is an enlarged view of a portion indicated by VII in FIG. 6. FIG. 8 is an enlarged view of a portion indicated by VIII in FIG. 6.

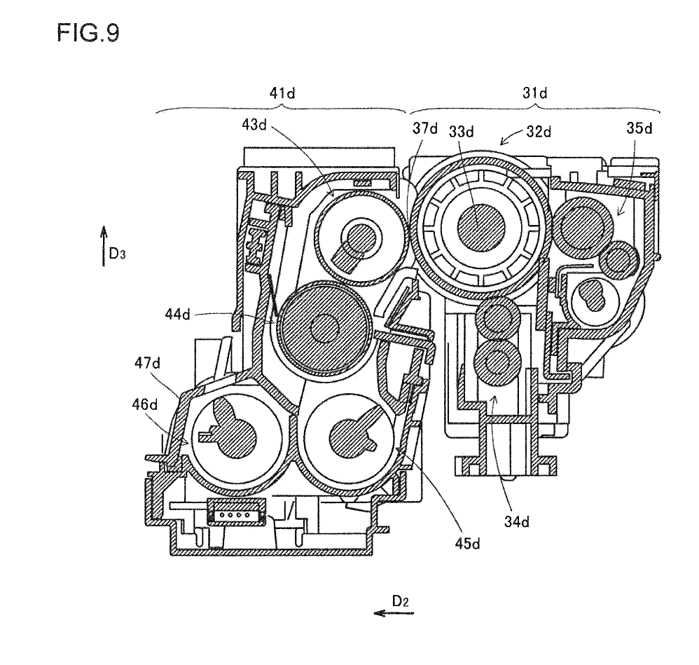

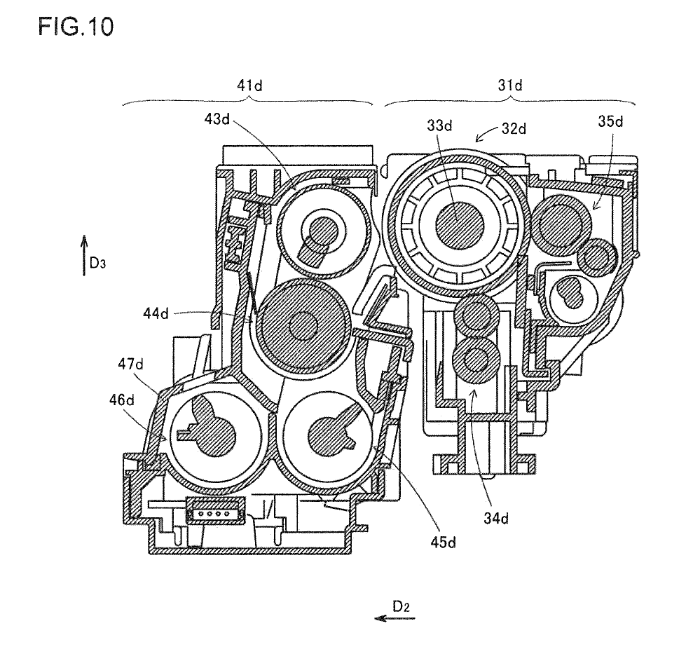

FIGS. 9 and 10 are cross sectional views in which the developing unit 41d is attached to the photoreceptor unit 31d. Each of FIGS. 9 and 10 illustrates a cross section taken along a plane perpendicular to a rotation axis 33d of the photoreceptor 32d. FIG. 9 illustrates a state in which the photoreceptor 32d and a developing sleeve 43d described later are closely disposed. FIG. 10 illustrates a state in which the photoreceptor 32d and the developing sleeve 43d are separated from each other. For ease of understanding, the same pattern of hatching is used for members in the drawings. Configurations of the yellow photoreceptor unit 31a and the yellow developing unit 41a, configurations of the magenta photoreceptor unit 3lb and the magenta developing unit 4lb, and configurations of the cyan photoreceptor unit 31c and the cyan developing unit 41c are similar to those of the black photoreceptor unit 31d and the black developing unit 41d, and thus, description thereof will not be repeated.

As illustrated in FIGS. 1 to 10, the photoreceptor unit 31d includes the photoreceptor 32d on which an electrostatic latent image is formed, a charging part 34d, and a cleaning part 35d (see particularly FIGS. 9 and 10). The photoreceptor 32d is in the shape of a circular tube, and can rotate about the rotation axis 33d in a direction indicated by an arrow R1 in FIG. 4. The charging part 34d applies a voltage necessary for forming an electrostatic latent image to the photoreceptor 32d. The charging part 34d is disposed below the photoreceptor 32d. The cleaning part 35d removes toner remaining on the photoreceptor 32d and electric charge. The cleaning part 35d is disposed at a side of the photoreceptor 32d. The cleaning part 35d includes a cylindrical toner discharge part 36d projecting toward the front of the photoreceptor unit 31d in order to discharge toner subjected to the cleaning.

The developing unit 41d includes the top cover 42d, the developing sleeve 43d, a magnetic roller 44d, a first stirring roller 45d, a second stirring roller 46d, a developer container 47d housing a developer (not shown). The top cover 42d is attached to the top of the developing unit 41d, and is detachably mounted on the developing unit 41d. The developing sleeve 43d is also called a developing roller. The magnetic roller 44d is also called a mag roller or a magnet roller.

The developing sleeve 43d is movable to a first position near the photoreceptor 32d and a second position separated from the photoreceptor 32d. The state illustrated in FIG. 9 is a state in which the developing sleeve 43d is at the first position. The state illustrated in FIG. 10 is a state in which the developing sleeve 43d is at the second position. The developing sleeve 43d can supply toner onto the surface of the photoreceptor 32d at the first position. While the developing sleeve 43d is at the first position, a toner layer formed on the surface of the developing sleeve 43d is very thin, and thus, the developing sleeve 43d and the photoreceptor 32d are almost in contact with each other at a closest location 37d. When the photoreceptor unit 31d or the developing unit 41d is detached from the body 21, the developing sleeve 43d is set at the second position.

In the magnetic roller 44d, N poles and S poles are alternately formed in a circumferential direction. The magnetic roller 44d holds a two-component developer on the surface thereof. The magnetic roller 44d supplies toner from the two-component developer held on the surface thereof to the developing sleeve 43d. A thin layer of toner supplied from the magnetic roller 44d is formed on the surface of the developing sleeve 43d.

The developer container 47d is configured in such a manner that the developing sleeve 43d, the magnetic roller 44d, and the first and second stirring rollers 45d and 46d are housed inside the developer container 47d. In the developer container 47d, the first and second stirring rollers 45d and 46d supply the developer to the magnetic roller 44d while stirring the developer. Toner consumed in development is supplied to the developer container 47d at any time. The developing sleeve 43d, the magnetic roller 44d, and the rotation axes of the first and second stirring rollers 45d and 46d are in parallel with the rotation axis 33d of the photoreceptor 32d.

The photoreceptor unit 31d and the developing unit 41d are attached to the body 21 of the image forming part 15. Specifically, the photoreceptor unit 31d and the developing unit 41d are inserted in a direction indicated by an arrow D₁ in FIG. 2 and attached to the body 21. On the other hand, the photoreceptor unit 31d and the developing unit 41d are drawn in the direction opposite to the direction indicated by the arrow D₁ in FIG. 2 and detached from the body 21.

Here, the photoreceptor unit 31d and the developing unit 41d are individually detachable from and attachable to the body 21. That is, the photoreceptor unit 31d can be detached from the body 21 without detaching the developing unit 41d from the body 21. The developing unit 41d can also be detached from the body 21 without detaching the photoreceptor unit 31d from the body 21.

In detaching the photoreceptor unit 31d or the developing unit 41d, the developing sleeve 43d is moved from the first position to the second position. The developing unit 41d includes a first attaching/detaching lever 48d that moves the developing sleeve 43d from the first position to the second position. The photoreceptor unit 31d includes a second attaching/detaching lever 38d that moves the developing sleeve 43d from the first position to the second position. The developing sleeve 43d is moved to the second position by lifting the first or second attaching/detaching lever 48d or 38d.

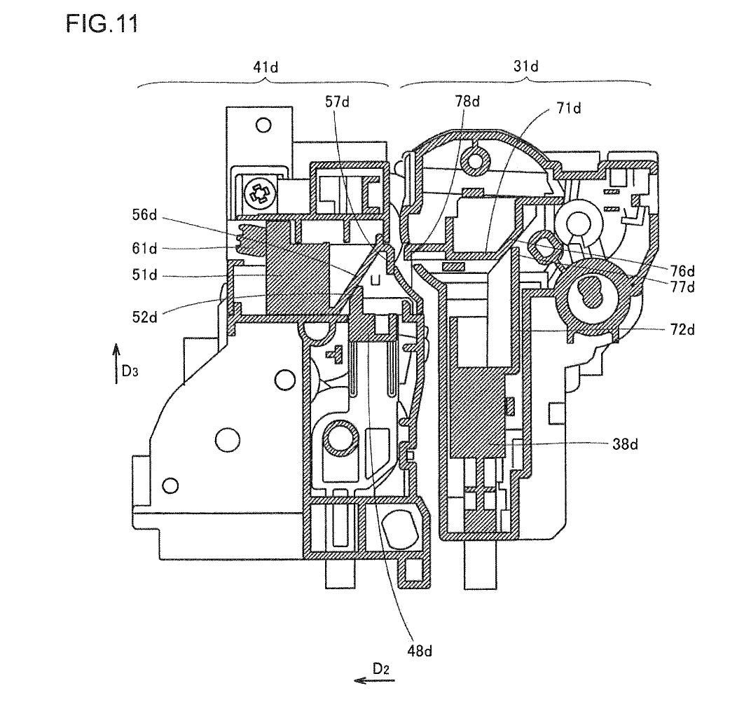

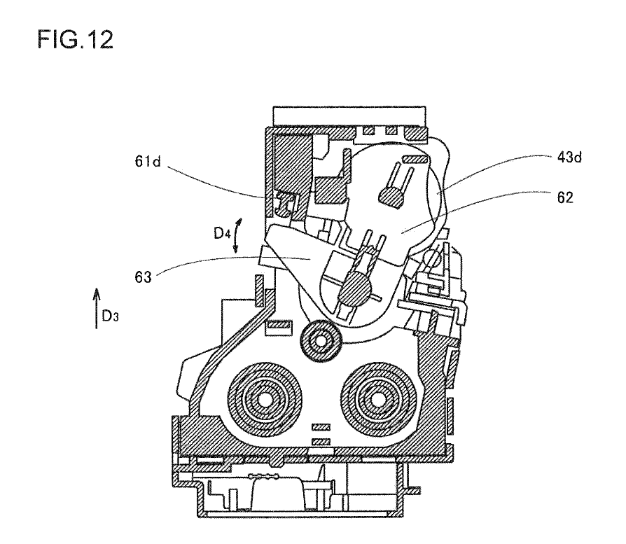

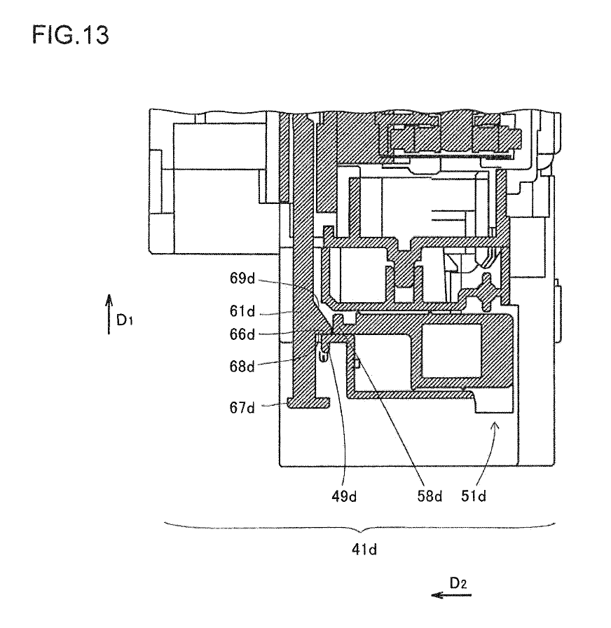

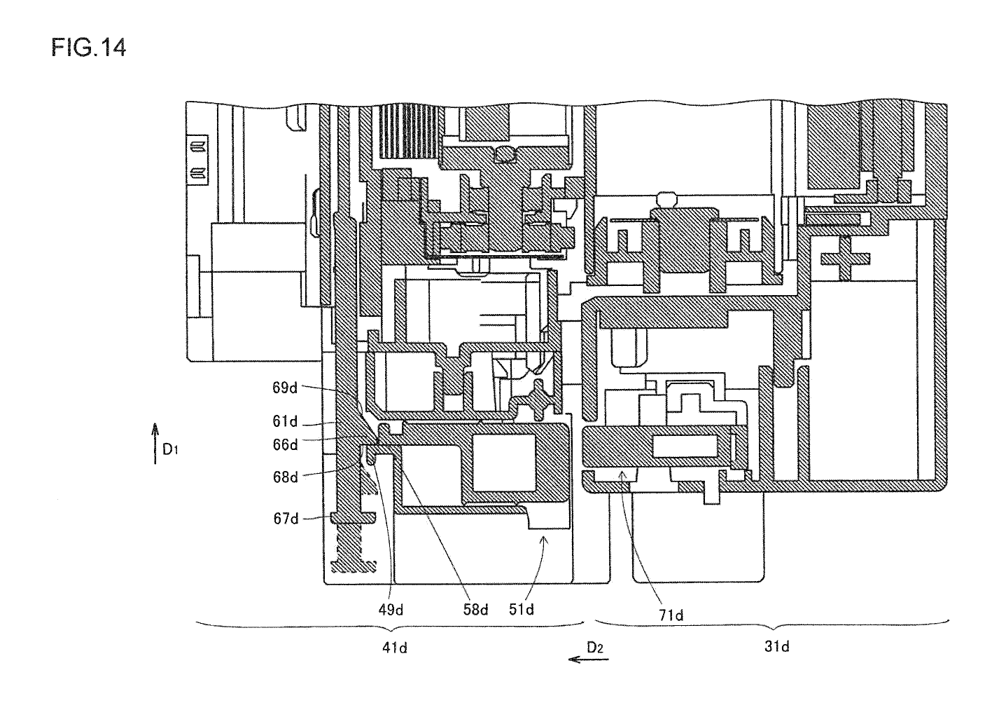

Specifically, the following configuration is employed. FIGS. 11 and 12 are cross sectional views illustrating a state in which the developing unit 41d is attached to the photoreceptor unit 31d. Each of FIGS. 11 and 12 illustrates a cross section taken along a plane perpendicular to the rotation axis 33d of the photoreceptor 32d. The cross section illustrated in FIG. 11 is different from those illustrated in FIGS. 9 and 10 in that the cross section illustrated in FIG. 11 does not include the developing sleeve 43d and the photoreceptor 32d but includes, for example, a first releasing member 51d described later. The cross section illustrated in FIG. 12 is different from those illustrated in FIGS. 9 and 10 in that the cross section illustrated in FIG. 12 does not include the developing sleeve 43d and the photoreceptor 32d but includes, for example, a rotation axis of the developing sleeve 43d described later. FIG. 13 is a cross sectional view illustrating the developing unit 41d. FIG. 14 is a cross sectional view illustrating the developing unit 41d and the photoreceptor unit 31d. Each of FIGS. 13 and 14 illustrates a cross section taken along a plane extending along the rotation axis 33d of the photoreceptor 32d.

With reference to FIGS. 1 to 14, especially FIGS. 11 to 14, a mechanism for moving the developing unit 41d between the first position and the second position will be described. The developing unit 41d includes the first attaching/detaching lever 48d, the first releasing member 51d, and a developing sleeve releasing lever 61d. The first attaching/detaching lever 48d is moved in up-and-down directions, that is, in a direction indicated by an arrow D₃ and an opposite direction thereof. The first attaching/detaching lever 48d is exposed at the front of the body 21 while the unillustrated front cover is open. That is, after opening the front cover, a user can operate the first attaching/detaching lever 48d to move the first attaching/detaching lever 48d in up-and-down directions.

A first attaching/detaching lever tilted part 52d is provided at an upper end of the first attaching/detaching lever 48d (see FIG. 11). A first hook 53d is integrally provided at a lower end of the first attaching/detaching lever 48d (see FIGS. 5 and 6). A front portion of the first hook 53d is constituted by a vertically extending plane 54d, and a plane of the first hook 53d extending from a lower end to the rear thereof is constituted by a tilted plane 55d that is tilted from the vertical direction. When the first attaching/detaching lever 48d moves downward, the first hook 53d projects from a lower face of the developing unit 41d.

In mounting the developing unit 41d on the body 21, the developing unit 41d is inserted along the tilted plane 55d, and accordingly, the first hook 53d moves upward. Thus, in pushing the developing unit 41d from the front to the rear of the body 21, movement of the developing unit 41d is not restricted by engagement of the first hook 53d with the body 21. When the developing unit 41d is pushed to a predetermined location in the body 21, contact between the first hook 53d and a part of the housing constituting the body 21 is canceled so that the first attaching/detaching lever 48d moves downward by its weight or a biasing force and the first hook 53d projects downward. In this state, the plane 54d at the front of the first hook 53d is engaged with a part of the housing of the body 21 so that forward movement of the developing unit 41d is restricted.

The first releasing member 51d is moved laterally, that is, a direction indicated by an arrow D₂ and an opposite direction thereof. With reference especially to FIG. 11, a first releasing member tilted part 56d that is tilted is provided at the right side of the first releasing member 51d. The first releasing member tilted part 56d is in contact with the first attaching/detaching lever tilted part 52d provided to the first attaching/detaching lever 48d. That is, the first releasing member 51d is in contact with the first attaching/detaching lever 48d. Since the first attaching/detaching lever tilted part 52d and the first releasing member tilted part 56d that are tilted in the same direction are in contact with each other, the first releasing member 51d can be moved laterally in cooperation with up-and-down movement of the first attaching/detaching lever 48d whose lateral movement is restricted. A first releasing member extension part 57d is provided at a right end of the first releasing member 51d, that is, at the right of the first releasing member tilted part 56d, and extends in up-and-down directions.

The developing sleeve releasing lever 61d is made of a resin material. The developing sleeve releasing lever 61d is a long slender rod-shaped member extending along the rotation axis of the developing sleeve 43d, that is, the direction indicated by the arrow D₁. The developing sleeve releasing lever 61d is flexible and can bend in a direction orthogonal to the direction indicated by the arrow D₁. The developing sleeve releasing lever 61d is supported by the developing unit 41d to be movable in the direction indicated by the arrow D₁ and the opposite direction thereof, and is biased to the direction opposite to the direction indicated by the arrow D₁, that is, biased from the rear to the front, by an unillustrated biasing member. The developing sleeve releasing lever 61d is integrally formed with a projection 64 that can be in contact with a cam part 63 of a bearing member 62 that rotatably holds the developing sleeve 43d (see FIG. 7). The projection 64 extends and is tilted in such a manner that the diameter of the developing sleeve releasing lever 61d increases from the front to the rear. Movement of the developing sleeve releasing lever 61d in the direction indicated by the arrow D₁ and the opposite direction thereof changes the contact state between the cam part 63 and the projection 64 and causes the bearing member 62 to shift in a direction indicated by an arrow D₄ in FIG. 12 so that the developing sleeve 43d is moved to a location between the first position and the second position.

The developing sleeve releasing lever 61d includes a pawl part 66d and a knob part 67d that are integrally formed near a front end of the developing sleeve releasing lever 61d (see FIGS. 13 and 14). The pawl part 66d is a wedge-shaped projection constituted by a plane 68d extending straight in the direction indicated by the arrow D₂ and a tilted plane 69d that is tilted and extends from the right end of the plane 68d in such a manner that the diameter of the pawl part 66d gradually decreases in the direction indicated by the arrow D₁. The knob part 67d projects toward the front of the developing unit 41d, and has a front edge that can be pushed rearward by a finger.

As illustrated in FIG. 14, the plane 68d of the pawl part 66d is hooked by a part of a housing 49d of the developing unit 41d so that movement of the developing sleeve releasing lever 61d forward against a biasing force of the biasing member is restricted. In this state, a left end 58d of the first releasing member 51d is in contact with the pawl part 66d of the developing sleeve releasing lever 61d.

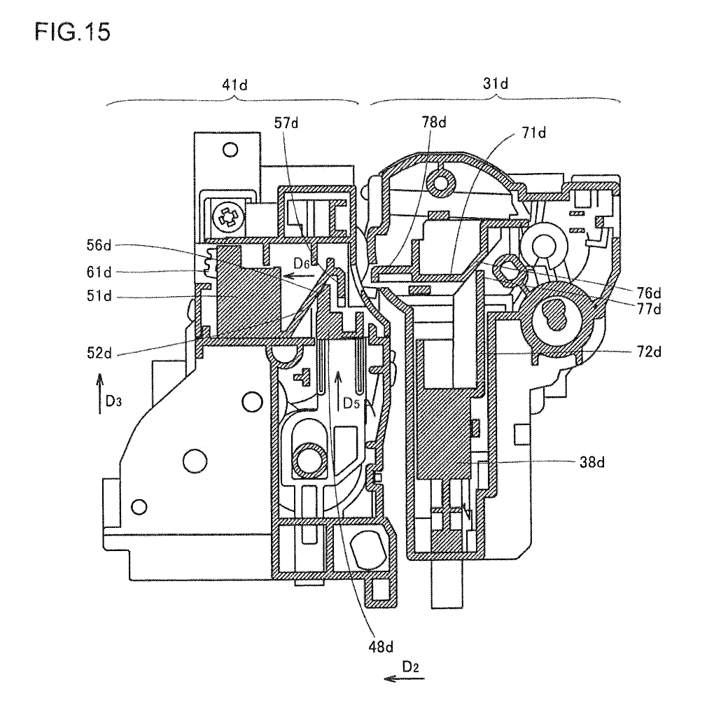

A method for moving the developing sleeve 43d from the first position to the second position by using the first attaching/detaching lever 48d will now be described. FIG. 15 is a cross sectional view illustrating the developing unit 41d and the photoreceptor unit 31d in this state. The cross section illustrated in FIG. 15 corresponds to the cross section illustrated in FIG. 11.

With also reference to FIG. 15, when the first attaching/detaching lever 48d is lifted in a direction indicated by an arrow D₅ in FIG. 15, since the first attaching/detaching lever tilted part 52d and the first releasing member tilted part 56d are in contact with each other, the first releasing member 51d moves to the left, that is, in the direction indicated by the arrow D₂, in cooperation with the lifting. For easy understanding, the arrow D₆ in FIG. 15 indicates the same direction as that indicated by the arrow D₂. When the pawl part 66d of the developing sleeve releasing lever 61d is pushed to the left (see FIG. 14) by the movement of the first releasing member 51d in the direction indicated by the arrow D₂ (arrow D₆), engagement of the developing sleeve releasing lever 61d with a part of the housing 49d of the developing unit 41d is canceled. This canceling causes the developing sleeve releasing lever 61d to move forward, that is, in the direction opposite to the direction indicated by the arrow D₁, by a biasing force of an unillustrated biasing member. The location to which the developing sleeve releasing lever 61d is moved is indicated by a broken line in FIG. 14. In cooperation with this movement, the contact state between the cam part 63 and the projection 64 is changed so that the developing sleeve 43d is moved to the second position. With upward movement of the first attaching/detaching lever 48d, the first hook 53d moves upward so that engagement of the first hook 53d with the part of the housing of the body 21 is canceled, and thus, the developing unit 41d can move forward.

As described above, after the developing sleeve 43d has been moved from the first position to the second position, the developing unit 41d can be detached from the body 21. In this manner, it is possible to detach the developing unit 41d from the body 21, while ensuring avoidance of interference between the developing sleeve 43d and the photoreceptor unit 31d. In this case, the developing unit 41d can be detached from the body 21 without detachment of the photoreceptor unit 31d. As a result, working efficiency can be enhanced.

A configuration for detaching the photoreceptor unit 31d will now be described. The photoreceptor unit 31d includes a second attaching/detaching lever 38d and a second releasing member 71d (see FIG. 11). The second attaching/detaching lever 38d can be moved in up-and-down directions, that is, in the direction indicated by the arrow D₃ and the opposite direction thereof. In a manner similar to the first attaching/detaching lever 48d, the second attaching/detaching lever 38d is exposed at the front of the body 21 while the unillustrated front cover is open. That is, after opening the front cover, a user can operate the second attaching/detaching lever 38d to move the second attaching/detaching lever 38d in up-and-down directions.

A second attaching/detaching lever extension part 72d is provided in an upper portion of the second attaching/detaching lever 38d and extends in up-and-down directions. A second hook 73d is integrally formed at a lower end of the second attaching/detaching lever 38d (see FIG. 4). The second hook 73d has a shape similar to that of the first hook 53d. A front portion of the second hook 73d is constituted by a vertically extending plane 74d. A plane of the second hook 73d extending from a lower end to the rear thereof is constituted by a tilted plane 75d that is tilted from the vertical direction.

When the second attaching/detaching lever 38d moves downward, the second hook 73d projects from a lower face of the photoreceptor unit 31d. In mounting the photoreceptor unit 31d on the body 21, the rear tilted plane 75d of the second hook 73d comes into contact with a part of the housing of the body 21 so that the second attaching/detaching lever 38d moves upward. Thus, rearward movement of the photoreceptor unit 31d is not restricted.

When the photoreceptor unit 31d is pushed to a predetermined location in the body 21, contact between the second hook 73d and a part of the housing constituting the body 21 is canceled so that the second attaching/detaching lever 38d moves downward by its weight or a biasing force and the second hook 73d projects downward. In this state, the plane 74d at the front of the second hook 73d is engaged with a part of the housing of the body 21 so that forward movement of the photoreceptor unit 31d is restricted.

The second releasing member 71d can be moved laterally, that is, in the direction indicated by the arrow D₂ and the opposite direction thereof. A second releasing member tilted part 76d that is tilted from the up-and-down directions is provided at the right of the second releasing member 71d. The second releasing member tilted part 76d is in contact with an upper end 77d of the second attaching/detaching lever extension part 72d. That is, the second releasing member 71d is in contact with the second attaching/detaching lever 38d. In cooperation with the up-and-down movement of the second attaching/detaching lever 38d, the second releasing member 71d can be moved laterally. That is, when the second attaching/detaching lever 38d whose lateral movement is restricted is moved upward, the second releasing member 71d is pushed along the slope of the second releasing member tilted part 76d that is in contact with the end 77d and moves to the left. The second releasing member extension part 78d located at the left end of the second releasing member 71d and extending in up-and-down directions is configured to come into contact with the first releasing member extension part 57d located at the right end of the first releasing member 51d.

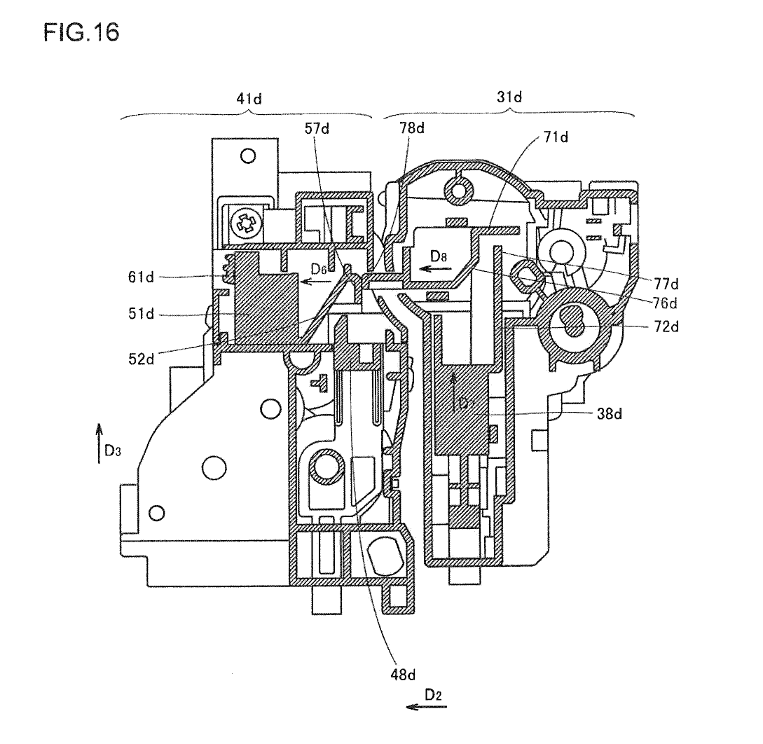

A method for moving the developing sleeve 43d from the first position to the second position by using the second attaching/detaching lever 38d will now be described. FIG. 16 is a cross sectional view illustrating the developing unit 41d and the photoreceptor unit 31d in this state. The cross section illustrated in FIG. 16 corresponds to the cross section illustrated in FIG. 11.

With also reference to FIG. 16, when the second attaching/detaching lever 38d is lifted in a direction indicated by an arrow D₇ in FIG. 16, since the end 77d of the second attaching/detaching lever extension part 72d and the second releasing member tilted part 76d are in contact with each other, the first releasing member 51d moves to the left, that is, moves in the direction indicated by the arrow D₂, in cooperation with the lifting. For easy understanding, an arrow D₈ in FIG. 16 indicates the same direction as that indicated by the arrow D₂. In the state illustrated in FIG. 16, the end 77d of the second attaching/detaching lever extension part 72d and the second releasing member tilted part 76d are not in contact with each other in the cross section of FIG. 16, but are in contact with each other in another cross section. The movement of the second releasing member 71d in the direction indicated by the arrow D₂ (arrow D₈) brings the second releasing member extension part 78d at the left end of the second releasing member 71d into contact with the first releasing member extension part 57d at the right end of the first releasing member 51d so that the first releasing member 51d is pushed in the same direction as that indicated by the arrow D₂ (arrow D₆). When the first releasing member 51d is pushed to the left, in a manner similar to that in lifting of the first attaching/detaching lever 48d, the pawl part 66d of the developing sleeve releasing lever 61d is pushed to the left so that engagement of the developing sleeve releasing lever 61d with a part of the housing 49d of the developing unit 41d is canceled. This canceling causes the developing sleeve releasing lever 61d to move forward, that is, in the direction opposite to the direction indicated by the arrow D₁, by a biasing force of an unillustrated biasing member. In cooperation with this movement, the contact state between the cam part 63 and the projection 64 is changed so that the developing sleeve 43d is moved to the second position. With upward movement of the second attaching/detaching lever 38d, the second hook 73d moves upward so that engagement of the second hook 73d with a part of the housing of the body 21 is canceled, and thus, the photoreceptor unit 31d can move forward.

After the developing sleeve 43d has been moved from the first position to the second position, the photoreceptor unit 31d can be detached from the body 21. In this manner, it is possible to detach the photoreceptor unit 31d from the body 21, while ensuring avoidance of interference between the photoreceptor unit 31d and the developing sleeve 43d. In this case, the photoreceptor unit 31d can be detached from the body 21 without detachment of the developing unit 41d. As a result, working efficiency can be enhanced.

As described above, in detaching the photoreceptor unit 31d from the body 21, the foregoing configuration enables detachment of only the photoreceptor unit 31d from the body 21 without detachment of the developing unit 41d from the body 21. Thus, complexity in work for attaching and detaching the developing unit 41d can be avoided and, in addition, the probability of scattering of toner occurring in detaching or attaching the developing unit 41d can be reduced, for example. In this case, since the developing sleeve 43d has been moved to the second position, interference between the photoreceptor 32d and the developing sleeve 43d can be avoided. Thus, the multifunctional peripheral 11 configured as described above can enhance working efficiency.

In addition, in the case of mounting one of the photoreceptor unit 31d or the developing unit 41d on the body 21, even if the other of the photoreceptor unit 31d or the developing unit 41d has been mounted on the body 21, since the developing sleeve 43d is at the second position, interference between the photoreceptor 32d and the developing sleeve 43d can be avoided. In this case, after the photoreceptor unit 31d and the developing unit 41d have been mounted on the body 21, the knob part 67 of the developing sleeve releasing lever 61d at a location indicated by a broken line in FIG. 14 is pushed in the direction indicated by the arrow D₁ so that the developing sleeve 43d can be moved to the first position relative to the photoreceptor unit 31d. When the developing sleeve releasing lever 61d is pushed from a location indicated by the broken line, a part of the housing 49d of the developing unit 41d comes into contact with the pawl part tilted plane 69d to be pushed to the right and partially bent by elasticity and the pawl part 66d is engaged with a part of the housing 49 of the developing unit 41d. In this manner, the developing sleeve 43d can be moved from the second position to the first position and held at this location.

In the embodiment described above, the direction of movement from the first position to the second position is perpendicular to the direction along which the rotation axis of the photoreceptor 42d extends. However, the present disclosure is not limited to this direction, and the direction of movement from the first position to the second position may be tilted from the direction along which the rotation axis extends, for example.

It should be understood that the embodiment and examples disclosed herein are illustrative and non-restrictive in every respect. The scope of the present disclosure is defined by the terms of the claims, rather than by the foregoing description, and is intended to include any modifications within the scope and meaning equivalent to the terms of the claims.

An image forming apparatus according to the present disclosure is especially useful in the case of requiring enhanced working efficiency.

What is claimed is:

1. An image forming apparatus comprising:
a body;
a photoreceptor unit including a photoreceptor having a surface on which an electrostatic latent image is formed, the photoreceptor unit being detachably mounted on the body; and
a developing unit configured to be detachably mounted on the body, including a developing sleeve for supplying a developer to the photoreceptor, and the developing sleeve is movable to a first position at which the developing sleeve is allowed to supply the developer to the photoreceptor and a second position at which the photoreceptor and the developing sleeve are separated from each other to avoid contact between the photoreceptor and the developing sleeve, wherein
the developing unit includes a first attaching/detaching lever that moves the developing sleeve from the first position to the second position by lifting the first attaching/detaching lever,
the photoreceptor unit includes a second attaching/detaching lever that moves the developing sleeve from the first position to the second position by lifting the second attaching/detaching lever, and
the photoreceptor unit and the developing unit move the developing sleeve to the second position by lifting the first attaching/detaching lever or the second attaching/detaching lever so that the photoreceptor unit and the developing unit are individually detached from the body.

2. The image forming apparatus according to claim 1, wherein
the developing unit includes a first releasing member that moves the developing sleeve from the first position to the second position, and
the photoreceptor unit includes a second releasing member that moves the developing sleeve from the first position to the second position.

3. The image forming apparatus according to claim 2, wherein
the first releasing member is in contact with the first attaching/detaching lever, and
the second releasing member is in contact with the second attaching/detaching lever.

4. The image forming apparatus according to claim 2, wherein
the first releasing member moves the developing sleeve from the first position to the second position or from the second position to the first position in cooperation with up-and-down movement of the first attaching/detaching lever, and
the second releasing member moves the developing sleeve from the first position to the second position or from the second position to the first position in cooperation with up-and-down movement of the second attaching/detaching lever.

5. The image forming apparatus according to claim 2, wherein
the second releasing member is in contact with the first releasing member, and
when the second attaching/detaching lever is lifted, the second releasing member moves the first releasing member in a direction in which the developing sleeve moves the second position.

6. The image forming apparatus according to claim 2, wherein
the first releasing member is in contact with a developing sleeve releasing lever for moving the developing sleeve.
